(19) United States
(12) Patent Application Publication
(10) Pub. No.: US 2019/0241707 A1
(43) Pub. Date: Aug. 8, 2019

(54) NATURAL ANTIOXIDANTS DERIVED FROM LIGNIN

(71) Applicant: ExxonMobil Research and Engineering Company, Annandale, NJ (US)

(72) Inventors: Virginia M. Reiner, Summit, NJ (US); Nabila Brabez, Logan Township, NJ (US); Ross Mabon, Whitehall, PA (US); Ashley M. Wittrig, Washington, NJ (US)

(21) Appl. No.: 16/366,224

(22) Filed: Mar. 27, 2019

Related U.S. Application Data
(62) Division of application No. 15/675,911, filed on Aug. 14, 2017.
(60) Provisional application No. 62/383,815, filed on Sep. 6, 2016.

(51) Int. Cl. C08H 7/00; C10M 159/02; C08L 97/00; C07G 1/00

(52) U.S. Cl. CPC C08H 6/00; C10M 159/02; C08L 97/005; C10N 2230/10; C10M 2209/12; C10M 2203/1006; C07G 1/00

(57) ABSTRACT

Technical lignin compositions and pyrolysis methods for forming such technical lignin compositions from pyrolyzed biomass are provided. The technical lignin compositions can include at least about 50 wt % phenolic polymers and/or at least about 75 wt % combined phenolic monomers and phenolic polymers. In some aspects, less than about 50 wt % of the linkages between benzylic units in the phenolic polymers and/or in the composition can correspond to β-O-4 linkages. At least about 50 wt % of the hydroxyl groups in the composition can correspond to phenolic hydroxyl groups. At least about 60 wt % of the phenolic hydroxyl groups and/or phenolic ether groups can correspond to phenolic hydroxyl groups and/or phenolic ether groups in an ortho position relative to at least one substituent.

### CROSS-REFERENCE TO RELATED APPLICATIONS

This application is a divisional application filed under 37 C.F.R. 1.53(b) of parent U.S. patent application Ser. No. 15/675,911 filed Aug. 14, 2017, the entire contents of which are incorporated herein by reference, and claims the benefit of U.S. Provisional Application No. 62/383,815, filed on Sep. 6, 2016, the entire contents of which are incorporated herein by reference.

### FIELD

This invention relates to methods for processing lignin-containing biomass and lignin compositions, typically derived therefrom.

### BACKGROUND

Developing renewable sources of feedstocks based on biomass for making lubricants is an area of ongoing interest. Use of biomass as a feedstock source is attractive from a perspective of avoiding depletion of mineral oil and gas sources. However, a variety of challenges remain in developing technologies for harvesting and processing feeds derived from biomass.

U.S. Patent Application Publication No. 2011/0306429 describes grease compositions including poly-phenolic additives derived from plants. Tannin is noted as an example of a poly-phenolic compound derived from plants.

International Publication No. WO/2015/178771 describes methods for fractionating technical lignins using an extraction column. Material including technical lignins is packed into a column as the stationary phase while solvents are passed through the column to separate lignins from the remaining portion of the material.

### SUMMARY

In various aspects, technical lignin compositions are provided, and methods of forming such technical lignin compositions are also provided. The technical lignin compositions can include at least about 60 wt % phenolic polymers, at least about 75 wt % combined phenolic monomers and phenolic polymers, or a combination thereof. Additionally or alternately, at least about 50 wt % of the hydroxyl groups in the technical lignin composition comprising phenolic hydroxyl groups. Additionally or alternately, at least about 60% of the phenolic hydroxyl groups and/or phenolic ether groups can correspond to phenolic hydroxyl groups and/or phenolic ether groups in an ortho position relative to at least one substituent or to two substituents (e.g., a methyl substituent, an ethyl substituent, a methoxy substituent, a hydroxyl substituent, an ether substituent, and/or a combination thereof). Additionally or alternately, about 70% or less of linkages connecting benzylic units in the phenolic polymers and/or the technical lignin composition can correspond to linkages including an ether group or a carbonyl group. Additionally or alternately, about 50% or less of linkages connecting benzylic units in the phenolic polymers and/or the technical lignin composition can correspond to β-O-4 linkages. Additionally or alternately, the phenolic polymers and/or the technical lignin composition can comprise a ratio of aromatic carbons to aliphatic carbons, exclusive of methoxy groups, of at least about 2.3.

In some embodiments, the technical lignin compositions and/or the combined phenolic monomers and phenolic polymers can comprise an effective hydrogen index of about 1.0 or less. In some embodiments, the technical lignin compositions can comprise about 5.0 wt % or less of sugars. In some embodiments, in the technical lignin compositions, about 30 wt % or less (or about 20 wt % or less or about 10 wt % or less) of the phenolic polymers comprise natural lignins. In some embodiments, at least about 60 wt % (or at least about 70 wt % or at least about 80 wt %) of the phenolic polymers comprise technical lignins and/or at least about 60 wt % (or at least about 70 wt % or at least about 80 wt %) of the phenolic polymers comprise pyrolytic lignins. In some embodiments, about 50% or less of linkages connecting benzylic units in the phenolic polymers and/or in the technical lignins comprise an ether group or a carbonyl group.

In some embodiments, the technical lignin compositions may comprise or be pyrolytic lignins formed according to a method comprising: pyrolyzing a biomass feed to form a pyrolysis product, at least a portion of which optionally comprising a pyrolysis oil; optionally fractionating the pyrolysis product to form a first fraction comprising phenolic monomers, phenolic polymers, or a combination thereof and a second lower boiling fraction; mixing at least a portion of the pyrolysis product with water to form a mixture; separating a water phase of the mixture from a second phase comprising the technical lignin composition; and optionally functionalizing at least a portion of the phenolic hydroxyl groups in the pyrolytic lignin composition, such as by performing alkylation and/or by performing a partial acetylation. In such embodiments, the water phase separation can comprise settling the mixture for a settling time to form the water phase and the second phase and separating the formed water phase from the second phase.

### BRIEF DESCRIPTION OF THE DRAWINGS

FIG. 1 schematically shows an example of a pyrolysis reactor.

FIG. 2 schematically shows an example of separation stages for separating a pyrolysis product into pyrolysis oil fractions.

FIG. 3 shows an example of a potential phenolic polymer.

FIG. 4 shows an example of an antioxidant compound.

FIG. 5 shows pressure differential scanning calorimetry results for greases including pyrolytic lignin compositions as an additive.

FIG. 6 shows Rotating Pressure Vessel Oxidation Test results for lubricants including a pyrolytic lignin composition or a conventional antioxidant as an additive.

FIG. 7 shows oxygen heteroatom classes for a pyrolytic lignin composition.

### DETAILED DESCRIPTION OF THE EMBODIMENTS

In various aspects, systems and methods are provided for forming pyrolytic lignin compositions comprising technical lignins from pyrolyzed biomass. The pyrolytic lignin compositions can comprise at least about 50 wt % phenolic polymers and/or at least about 75 wt % combined phenolic monomers and phenolic polymers. In some aspects, less than about 50 wt % of the linkages between benzylic units in the phenolic polymers and/or in the composition can correspond to β-O-4 linkages. At least about 50 wt % of the hydroxyl groups in the composition can correspond to phenolic hydroxyl groups. In some aspects, at least about 60 wt % of the phenolic hydroxyl groups can correspond to phenolic hydroxyl groups in an ortho position relative to at least one substituent (i.e., ortho to one substituent or ortho to two substituents). Additionally or alternately, at least about 60 wt % of the phenolic ethers in the phenolic monomers and/or polymers can correspond to ethers in an ortho position relative to at least one substituent.

Technical lignins refer to structures derived from lignin compounds in biomass. Natural lignins in biomass can correspond to compounds formed from aromatic (monomer) building blocks corresponding to syringyl alcohol, guaiacyl or conforyl alcohol, and coumaryl alcohol. Technical lignins can be formed from a variety of techniques, such as by hydrothermal processing, Kraft pulping, Organosolv™ extraction or pulping, sulfite pulping, and cellulosic bioethanol refining. In pulping processes, the primary product can correspond to purified cellulose fibers, with technical lignins formed as a side or residual product. Similarly, during hydrothermal processing, the primary product can correspond to a desired fuel boiling range product, with technical lignins formed as a side or residual product. Due to the severity of processes such as pulping processes and hydrothermal processing, technical lignins can correspond to compounds that have been chemically changed relative to the native lignins present in the biomass prior to processing. As a result, the monomers in a technical lignin may not correspond to the traditional monomers found in a natural lignin. The composition of the technical lignins can also vary depending on the nature of the process used to form the technical lignins.

The above methods for making technical lignins can relate to processes for treating biomass to separate of cellulose from other products. Another option for processing of biomass can correspond to methods involving pyrolysis. Pyrolysis of biomass can be used to convert at least a portion of biomass into fractions that may be suitable as substitutes and/or complements to mineral feeds in petroleum processing. Pyrolysis can also result in production of technical lignins as a side product, but conventionally such technical lignins, which can also be referred to as pyrolytic lignins, have been viewed as an undesirable product.

It has been determined that pyrolytic lignin compositions comprising technical lignins derived from pyrolysis of biomass can be suitable for use as antioxidant additives in, for example, lubricating oil compositions. In some aspects, a pyrolytic lignin composition can provide improved antioxidant properties relative to conventional antioxidants derived from mineral oil sources. In this discussion, a “technical lignin composition” or a “pyrolytic lignin composition” can refer to a composition including technical lignins (such as pyrolytic lignins). It is noted that a reference to technical/pyrolytic lignin composition can typically include compounds other than technical lignins. Due to the variety of types of technical lignins that can be present in a technical/pyrolytic lignin composition, such compositions are specified herein by specifying the nature of various components, compounds, and/or functional groups within a composition, such as characterization of phenolic polymers within a composition. Thus, identifying a technical lignin composition as described herein is not dependent on identifying whether particular compounds in a composition strictly meet the definition of a technical lignin.

In this discussion, a benzylic unit can correspond to an aromatic six-member carbon ring structure that is part of a larger compound. Because a benzylic unit is part of a larger compound, by definition a benzylic unit can be substituted at least once. A benzylic unit can be substituted with any convenient number of substituents, including non-aromatic ring substituents.

In this discussion, a phenolic polymer can correspond to a compound including a plurality of benzylic units having at least one hydroxyl substituent and/or at least one ether substituent that can provide a linkage to another benzylic unit. A phenolic monomer that is part of a phenolic polymer can correspond to a portion of a phenolic polymer including a single benzylic unit having at least one hydroxyl substituent and/or an ether substituent providing a linkage to another benzylic unit. A phenolic monomer that is a separate compound (i.e., not part of a phenolic polymer) can correspond to a compound including a single benzylic unit having at least one hydroxyl substituent. A hydroxyl substituent on a benzylic unit can be referred to as a phenolic hydroxyl substituent.

In this discussion, the terms “pyrolyze” and “pyrolyzing” can correspond to the act of converting a compound by pyrolysis. Pyrolysis can correspond to a process for conversion of a feed material into one or more products based on heating of the feed material. Optionally, reactions that can occur by heating in the presence of substantially reactive compounds (e.g., oxygen, hydrogen, sulfur-containing gases, and the like, but not including catalysts) to cause any significant degree of reaction involving (e.g., oxidation of) the feed material, such as by side reactions, can be substantially excluded during pyrolysis. The terms “thermolysis” or “thermal reaction” can be considered as synonyms for the term pyrolysis. According to the present invention, the term “torrefaction” can also be considered within the definition of pyrolysis.

The term “biomass,” for the purposes of the present invention, can correspond to any material not derived from fossil/mineral resources and comprising carbon, hydrogen, and oxygen. Examples of biomass can include, but are not limited to, plant and plant-derived material, algae and algae-derived material, vegetation, agricultural waste, forestry waste, wood waste, paper waste, animal-derived waste, poultry-derived waste, municipal solid waste, cellulose and cellulosics, carbohydrates or derivatives thereof, charcoal, and the like, and combinations thereof. The feedstock can also comprise pyrolyzable components other than biomass, such as fossil/mineral fuels (e.g., coal, crude or refined petroleum feedstocks, and the like, as well as combinations thereof).

### Pyrolysis of Biomass

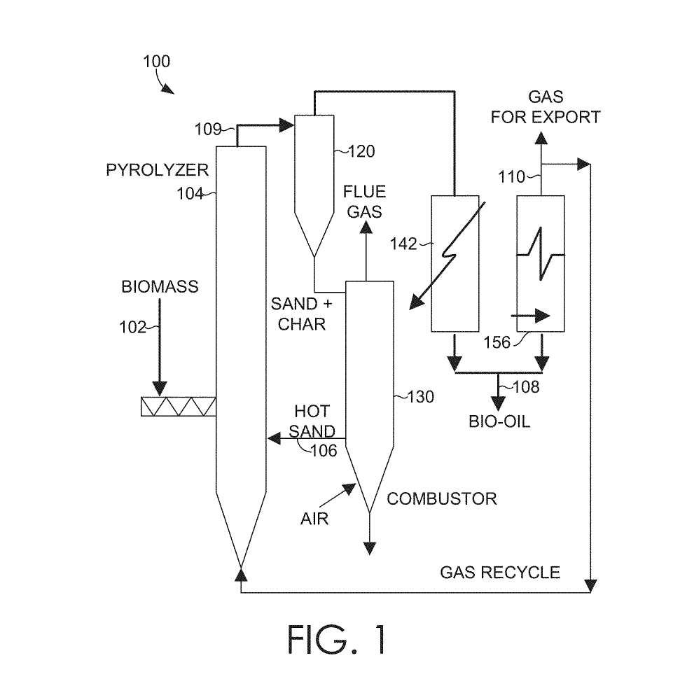

Pyrolysis can be used to convert biomass into a composition including technical lignins. FIG. 1 schematically illustrates an example of a configuration 100 of a pyrolysis reactor suitable for producing pyrolysis bio-oil. In the example shown in FIG. 1, bio-oil 108 can be produced from pyrolysis of biomass 102, such as wood chips or corn stover. Depending on the source, bio-oil 108 can be a complex mixture of organic oxygenates, characterized by high oxygen content (>35 wt %), reactive oxygen functional groups, thermal instability, corrosivity, low energy content and a significant water fraction (˜10-20 wt %), making it unsuitable for use as a refinery feedstock or transportation fuel without significant further upgrading. Bio-oil 108 can typically be produced using a fast pyrolysis process, where dry solid biomass is converted to liquid products using a reactor with high heat transfer rates, e.g., a fluidized bed reactor.

In a fast pyrolysis reactor, biomass 102 can be fed to a pyrolyzer 104 where it can be contacted with a circulating heat transfer medium, typically a fine, hot sand 106, resulting in high heating rates, on the order of 1000° C./sec. Optionally, the heat transfer medium can include catalyst particles. Catalyst included as part of the heat transfer medium can correspond to catalyst for catalyzing the pyrolysis reaction, catalyst for hydrogenating or otherwise stabilizing the resulting pyrolysis products, or a combination thereof. Average temperatures at the outlet of the pyrolyzer are ˜500° C., with a typical residence time of less than two seconds. The biomass 102 can undergo thermal depolymerization of the lignin and cellulose molecules, resulting in a complex mixture of oxygenated organics following rapid cooling. The resulting pyrolysis effluent 109 can then be passed into a separator such as a cyclone 120 for separation of fluid pyrolysis products from solid particles. During pyrolysis, particles of the heat transfer medium (e.g., sand) can become entrained in the upward flow in the reactor. Additionally, particles of char can form during pyrolysis. The char can typically circulate with the sand back to the combustor 130 where it can provide the heat required to bring the sand back to the desired temperature for the pyrolyzer 104. After separation of particles from pyrolysis effluent 109, the fluid pyrolysis products can be passed through various additional types of separation stages. In FIG. 1, the fluid pyrolysis products are passed through a condenser 142 and an electrostatic precipitator 156 to form bio-oil 108. In addition to the bio-oil 108 produced, a gas 110 (comprising predominately CO, CO₂, and H₂O) can be formed.

A wide range of feedstocks of various types, sizes, and moisture contents can be processed according to aspects of the present invention. Feedstocks that can be used in aspects of the present invention can comprise any hydrocarbon that can be thermally decomposed and/or transformed. Preferably, the feedstock comprises biomass, particularly biomass not typically processed or easily processable through chemical reactions. For example, the feedstocks can be comprised of at least 10 wt %, or at least 30 wt %, or at least 50 wt %, or at least 70 wt %, or at least 90 wt % biomass, such as up to 95 wt % or more, based on total weight of feedstock processed or supplied to the thermal or pyrolysis reactor. In particular, the feedstocks can be comprised of 10 wt % to 100 wt % biomass, or 10 wt % to 95 wt %, or 50 wt % to 100 wt %.

Additional or alternate examples of biomass that can be included as feedstock components include, but are not limited to, timber harvesting residues, softwood chips, hardwood chips, tree branches, tree stumps, leaves, bark, sawdust, off-spec paper pulp, corn, corn cob, corn stover, wheat straw, rice straw, sugarcane, bagasse, switchgrass, miscanthus, animal manure, municipal garbage, municipal sewage, commercial waste, grape pumice, almond shells, pecan shells, coconut shells, coffee grounds, grass pellets, hay pellets, wood pellets, cardboard, paper, plastic, cloth, and combinations thereof.

The biomass to be pyrolyzed may be ground prior to pyrolyzing. For example, the biomass can be ground in a mill until a desired particle size is achieved. In one embodiment, the particle size of the biomass to be pyrolyzed can be sufficient (with or without grinding) to pass through a 30 mm screen, for example a 20 mm screen, a 10 mm screen, a 5 mm screen, or a 1 mm screen, such as down to a 0.5 mm screen. In particular, the particle size of the biomass can be sufficient to pass through a 0.5 mm screen to a 30 mm screen, or 0.5 mm screen to a 20 mm screen, or a 0.5 mm screen to a 10 mm screen.

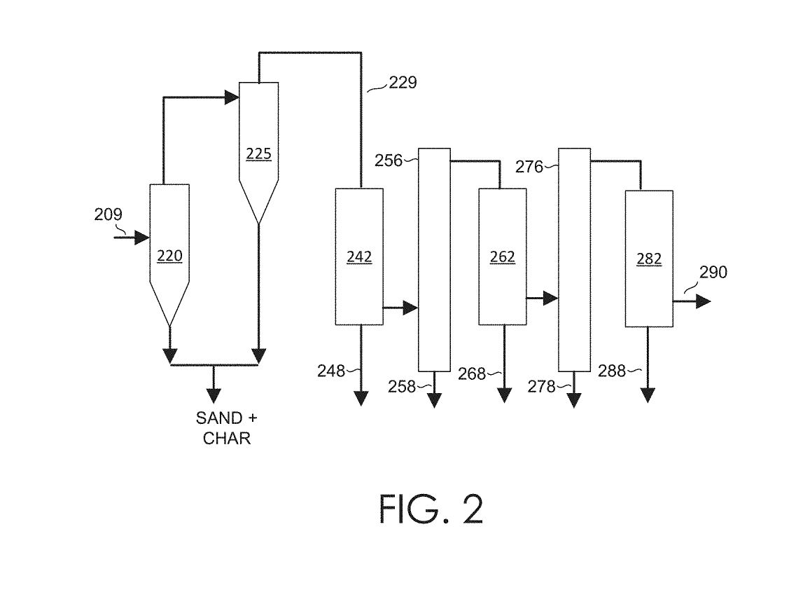

The example configuration shown in FIG. 1 can include a cyclone 120, a condenser 142, and an electrostatic precipitator 148. In the example configuration shown in FIG. 1, a single bio-oil product 108 can be formed. FIG. 2 shows another example of separation stages that can be used for separation of pyrolysis oil from other products. In FIG. 2, a plurality of cyclones, condensers, and electrostatic precipitators can be used to generate a plurality of pyrolysis oil fractions.

In FIG. 2, a pyrolysis effluent 209 can be passed into a first cyclone 220 for performing a gas-liquid separation. The overhead gas from cyclone 220 can be passed into a second stage cyclone 225 to further remove particles of char and/or catalyst from the gas flow. The overhead flow 229 from second stage cyclone 225 can then be passed into a condenser 242. Condenser 242 can be operated at a first temperature higher than the temperature of the subsequent condensers in the separation stage, such as condenser 262 and condenser 282. Similarly, condenser 262 can be operated at a higher temperature than condenser 282. This can allow the resulting condensed pyrolysis oil products 248, 268, and 288 to correspond to pyrolysis oil fractions with different boiling ranges. Similarly, electrostatic precipitators 256 and 276 can be operated at different temperatures, to allow pyrolysis oil products 258 and 278 to correspond to pyrolysis oil fractions with different boiling ranges. An electrostatic precipitator can assist with removal of aerosols from the flow in the separation stage. As a result, pyrolysis oil products 258 and 278 are not necessarily distinct in boiling range from pyrolysis products 248, 268, and/or 288. In some aspects, it can be desirable to combine pyrolysis oil product 248 with pyrolysis product 258, as both products can correspond to similar and/or overlapping boiling ranges.

As an example, overhead flow 229 can have a temperature of greater than about 300° C. (or greater than about 340° C.) when entering condenser 242. A pyrolysis oil product 248 can be generated along with a remaining portion passed into electrostatic precipitator 252. Condenser 242 can be operated so that the temperature of the remaining portion passed into electrostatic precipitator 252 can have a temperature of about 100° C. or greater. Electrostatic precipitator 256 can generate a pyrolysis oil product 258 and a remaining portion passed into condenser 262. Electrostatic precipitator 256 can be operated so that the remaining portion passed into condenser 262 can have a temperature of at least about 120° C. Thus, electrostatic precipitator 256 can generate a pyrolysis oil product 258 having a similar and/or overlapping boiling range with pyrolysis product 248, with pyrolysis product 258 potentially including a greater portion of pyrolysis effluent initially in the form of an aerosol. In this type of example, pyrolysis oil products 248 and 258 can correspond to pyrolysis oil fractions containing technical lignins.

The remaining uncondensed portion 290 of the pyrolysis effluent can correspond to a light ends type product containing CO, CO₂, C₄-hydrocarbons, and other similarly low boiling compounds. The uncondensed portion 290 can be further processed and/or used for any convenient purpose.

Deriving a Pyrolytic Lignin Composition from Biomass by Pyrolysis

After performing pyrolysis of biomass, such as under fast pyrolysis conditions, the resulting pyrolysis products can be separated into a plurality of fractions. FIG. 2 provides an example of forming a plurality of pyrolysis oil fractions where two of the fractions include technical lignins. In some aspects, other separation schemes can be used to result in technical lignins being present in a different number of pyrolysis oil fractions. Such fractions can be referred to as pyrolytic lignin fractions. Pyrolysis oil fractions having an initial boiling point or 5 wt % distillation point of at least about 90° C., or at least about 100° C., can contain a suitable amount of technical lignins for further processing. A boiling point and/or fractional weight distribution can be determined by a suitable method, such as ASTM D86, ASTM D2887, or another suitable method for characterizing a hydrocarbon fraction containing a substantial number of heteroatoms. It is noted that still lower boiling portions of a pyrolysis oil can be included as part of a pyrolysis oil fraction containing technical lignins. However, such lower boiling portions can typically correspond to a diluent, as technical lignins can be expected to have boiling points of about 90° C. or greater. In particular, a pyrolysis oil fraction can have a 5 wt % boiling point of about 90° C. to about 150° C., or about 90° C. to about 130° C., or about 100° C. to about 150° C.

After forming pyrolysis oil fractions, any desired pyrolysis oil fractions containing technical lignins can be further processed to separate a technical lignin composition from at least some other components of the pyrolysis oil. In particular, pyrolysis oil fraction(s) can be further processed to remove at least a portion of any sugars present in the pyrolysis oil fraction(s).

In some aspects, a process for separating sugar from a pyrolysis oil fraction can include washing the sample with water. Mixing with water can lead to precipitation and/or separation of lignins as an insoluble phase and/or an oil-based phase, while the sugars can be retained in an aqueous phase. For example, water can be added to a pyrolysis oil fraction in a convenient ratio. The ratio of water to pyrolysis oil can range from about 0.3 to about 3.0, or about 0.5 to about 3.0, or about 0.3 to about 1.5, such as about 1.0. The mixture of water and pyrolysis oil can then be stirred until the mixture is well mixed. The mixture can then be separated using a physical separation. As an example, the mixture can be allowed to settle for a period of time, followed by using a centrifuge to further separate a lower density portion and a higher density portion. The settling time can correspond to any convenient time, such as about 1 minute to about 24 hours or more, or about 0.5 hours to about 24 hours, or about 0.5 hours to about 10 hours. Optionally, the settling can be accompanied by mild shaking, such as by use of a shaking table, to facilitate settling. The settled mixture can be centrifuged for a convenient amount of time, such as about 1 minute to about 5 hours, or about 5 minutes to about 5 hours. The lower density portion can correspond to a primarily oil-based phase while the higher density portion can correspond to an aqueous phase. The aqueous phase can then be decanted off or otherwise removed from the mixture, leaving behind a washed oil-based phase with a reduced content of sugars. After removal of sugars, an oil-based phase and/or a pyrolytic lignin composition derived from an oil-based phase can have a sugar content of about 5.0 wt % or less, or about 1.0 wt % or less, such as down to about 0.1 wt % or less. In particular, the sugar content can be about 0 wt % to about 5.0 wt %, or about 0.1 wt % to about 5.0 wt %, or about 0 wt % to about 1.0 wt %.

### Pyrolytic Lignin Composition and Properties

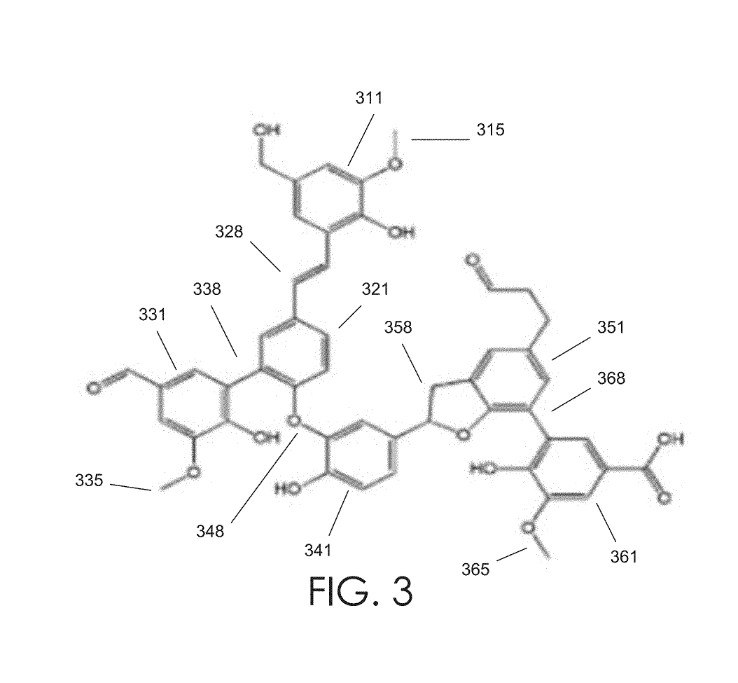

A composition including pyrolytic lignins as described herein can have a variety of compositional features. In order to illustrate potential compositional features, FIG. 3 shows an example of a possible technical lignin that may be present in a pyrolytic lignin composition. It is understood that the structure shown in FIG. 3 is only an illustration, and pyrolytic lignin compositions may exist that do not include the structure shown in FIG. 3.

As an initial note, the structure in FIG. 3 potentially corresponds to only a portion of a compound. FIG. 3 shows that benzylic units 311, 331, and 361 can each include a functional group including an oxygen atom with an oxygen bond 315, 335, or 365. The nature of the structure in FIG. 3 can depend in part on what oxygen bonds 315, 335, and/or 365 are bonded to. In some aspects, one or more of oxygen bonds 315, 335, and 365 can be bonds to hydrogen atoms. In aspects where each of oxygen bonds 315, 335, and 365 are bonds to hydrogen atoms, the structure in FIG. 3 can represent a complete compound. In some aspects, one or more of oxygen bonds 315, 335, and 365 can correspond to bonds to another type of terminating group. For example, if the terminating group for oxygen bond 315 is a methyl group, the resulting total functional group from the benzylic unit 311 can correspond to a methoxy group. In some aspects, one or more of oxygen bonds 315, 335, and 365 can correspond to bonds that start linkages to other benzylic units (not shown). In such aspects, the structure in FIG. 3 can correspond to a portion of a larger pyrolytic lignin.

The basic building block of a lignin can correspond to a phenolic monomer, which can correspond to phenol or a phenol derivative (including derivatives where the hydroxyl group of the phenol is converted to an ether). When two or more phenolic monomers are linked by a linkage, the resulting structure can correspond to a phenolic polymer. In some aspects, a pyrolytic lignin composition can comprise at least about 60 wt % of phenolic polymers, or at least about 70 wt %, or at least about 80 wt %, such as up to about 95 wt % or up to about 100 wt %. In particular, a pyrolytic lignin composition can comprise about 60 wt % to about 100 wt % of phenolic polymers, or about 60 wt % to about 95 wt %, or about 70 wt % to about 100 wt %. Additionally or alternately, a pyrolytic lignin composition can include both phenolic monomers and phenolic polymers. In some aspects, a pyrolytic lignin composition can comprise at least about 75 wt % of combined phenolic monomers and phenolic polymers, or at least about 85 wt %, or at least about 95 wt %, such as up to about 98 wt % or up to about 100 wt %. In particular, a pyrolytic lignin composition can comprise about 75 wt % to about 100 wt % of combined phenolic monomers and phenolic polymers, or about 75 wt % to about 98 wt %, or about 85 wt % to about 100 wt %.

The structure shown in FIG. 3 includes six different benzylic units. Each benzylic unit in FIG. 3 can correspond to a phenolic monomer. Benzylic unit 311 can include two hydroxyl substituents, as well as a potential third hydroxyl substituent based on oxygen bond 315. Benzylic unit 321 can correspond to a phenolic monomer based on the ether linkage 348 to benzylic unit 341. Benzylic unit 331 can include both a hydroxyl group and a potential second hydroxyl substituent based on oxygen bond 335. Benzylic unit 341 can include a hydroxyl group in addition to ether linkage 348. Benzylic unit 351 can include an ether linkage as part of ring structure linkage 358. Benzylic unit 361 can include a hydroxyl group and a potential second hydroxyl group based on oxygen bond 365. In some aspects, at least about 50 wt % of the hydroxyl groups in a pyrolytic lignin composition can correspond to phenolic hydroxyl groups, or at least about 60 wt %, or at least about 70 wt %, such as up to about 95 wt % or up to about 100 wt %. In particular, about 50 wt % to about 100 wt % of the hydroxyl groups can correspond to phenolic hydroxyl groups, or about 50 wt % to about 95 wt %, or about 60 wt % to about 100 wt %. Additionally or alternately, in some aspects at least about 50 wt % of the hydroxyl groups in technical lignins and/or phenolic monomers and/or phenolic polymers in the pyrolytic lignin composition can correspond to phenolic hydroxyl groups, or at least about 65 wt %, or at least about 80 wt %, such as up to about 95 wt % or up to about 100 wt %. In particular, about 50 wt % to about 100 wt % of the hydroxyl groups can correspond to phenolic hydroxyl groups, or about 65 wt % to about 95 wt %, or about 65 wt % to about 100 wt %.

Benzylic units can be connected to each other by linkages. A linkage refers to any bonds and corresponding intervening atoms providing connectivity between two benzylic units. FIG. 3 shows examples of various types of linkages. Benzylic unit 311 can be linked to benzylic unit 321 by linkage 328. Linkage 328 can correspond to two additional carbon atoms between benzylic unit 311 and benzylic unit 321. It is noted that the combination of benzylic unit 311, benzylic unit 321, and linkage 328 may correspond to a conjugated pi-bond system. Benzylic unit 321 can be linked to a total of three benzylic units. In addition to being linked to benzylic unit 311 via linkage 328, benzylic unit 321 can also be linked to benzylic unit 331 via linkage 338 and to benzylic unit 341 via linkage 348. Linkage 338 can correspond to a carbon-carbon bond between atoms in the aromatic rings of benzylic units 321 and 331. It is noted that linkage 338 need not include any atoms and can correspond only to the bond between benzylic units 321 and 331. Linkage 348 can correspond to an ether functional group between benzylic units 321 and 341. Benzylic unit 341 can also be linked to benzylic unit 351 by linkage 358. Linkage 358 can correspond to a ring structure including an oxygen heteroatom between benzylic units 341 and 351. It is noted that the ring structure of linkage 358 can be bonded to two separate carbon atoms in benzylic unit 351. Finally, benzylic unit 351 can be linked to benzylic unit 361 by linkage 368. Linkage 368 can correspond to a carbon-carbon bond between atoms in the aromatic rings of benzylic units 351 and 361. Of the linkages shown in FIG. 3, linkages 328, 338, and 368 can correspond to linkages involving only carbon-carbon bonds. In some aspects, at least about 50% of the linkages in phenolic polymers in a pyrolytic lignin composition can correspond to linkages involving only carbon-carbon bonds, or at least about 60%, or at least about 70%, such as up to about 95% or up to about 100%. In particular, about 50% to about 100% of the linkages can correspond to linkages involving only carbon-carbon bonds, or about 50% to about 95%, or about 60% to about 100%.

It is noted that none of the linkages shown in FIG. 3 correspond to β-O-4 linkages. In natural lignins, a β-O-4 linkage can represent the most common form of linkage between benzylic groups. A β-O-4 linkage can correspond to an aliphatic chain between two benzylic units including an oxygen atom and two carbon atoms. The oxygen atom can be bonded to one of the benzylic groups to form an ether, while the other two carbon atoms can provide a total chain length of three atoms between the benzylic units. In various aspects, about 50% or less of the linkages between benzylic units in the technical lignins and/or phenolic polymers of a pyrolytic lignin composition can correspond to β-O-4 linkages, or about 35% or less, or about 20% or less, such as down to about 5% or down to about 0%. In particular, about 50% to about 0% of the linkages between benzylic units can correspond to β-O-4 linkages, or about 50% to about 5%, or about 35% to about 0%. Additionally or alternately, about 70% or less of the linkages between benzylic units in the technical lignins and/or phenolic polymers can correspond to linkages including an ether group (i.e., —C—O—C—) or a carbonyl group (i.e., C═O) or about 50% or less, or about 35% or less, or about 20% or less, such as down to about 5% or down to about 0%. In particular, about 70% to about 0% of the linkages can correspond to linkages including an ether group or a carbonyl group, or about 50% to about 5%, or about 35% to about 0%.

Another compositional feature shown in FIG. 3 can be related to the relative position of hydroxyl and/or ether substituents in comparison to other substituents for a benzylic unit. For benzylic unit 311, one of the hydroxyl substituents can be in an ortho position relative two other substituents: the oxygen corresponding to oxygen bond 315, and the carbon chain corresponding to linkage 328. For benzylic unit 321, the ether bond corresponding to linkage 348 can be ortho to the carbon bond corresponding to linkage 338. For benzylic unit 331, one of the hydroxyl substituents can be in an ortho position relative two other substituents: the oxygen corresponding to oxygen bond 335, and the carbon bond corresponding to linkage 338. For benzylic unit 341, the hydroxyl group and the ether bond corresponding to linkage 348 can be ortho to each other. For benzylic unit 351, the ether in the ring structure linkage 358 can be ortho to the other bonding location for the ring structure linkage 358 and ortho to the bond corresponding to linkage 368. For benzylic unit 361, one of the hydroxyl substituents can be in an ortho position relative two other substituents: the oxygen corresponding to oxygen bond 365, and the carbon bond corresponding to linkage 368.

In some aspects, at least about 60 wt % of the phenolic hydroxyl groups in the pyrolytic lignin composition can correspond to phenolic hydroxyl groups in an ortho position relative to at least one substituent (optionally two substituents), or at least about 70 wt %, or at least about 80 wt %, such as up to about 95 wt % or up to about 100 wt %. In particular, about 60 wt % to about 100 wt % of the phenolic hydroxyl groups can correspond to phenolic hydroxyl groups in an ortho position relative to at least one substituent, or about 60 wt % to about 95 wt %, or about 70 wt % to about 100 wt %. Additionally or alternately, in some aspects at least about 60 wt % of the phenolic hydroxyl groups in in technical lignins and/or phenolic monomers and/or phenolic polymers in the pyrolytic lignin composition can correspond to phenolic hydroxyl groups in an ortho position relative to at least one substituent (optionally two substituents), or at least about 70 wt %, or at least about 80 wt %, such as up to about 95 wt % or about 100 wt %. In particular, about 60 wt % to about 100 wt % of the phenolic hydroxyl groups can correspond to phenolic hydroxyl groups in an ortho position relative to at least one substituent, or about 60 wt % to about 95 wt %, or about 70 wt % to about 100 wt %. In some aspects, at least about 60 wt % of the combined phenolic hydroxyl groups and phenolic ethers in the pyrolytic lignin composition can correspond to phenolic hydroxyl groups and phenolic ethers in an ortho position relative to at least one substituent (optionally two substituents), or at least about 70 wt %, or at least about 80 wt %, such as up to about 95 wt % or up to about 100 wt %. In particular, about 60 wt % to about 100 wt % of the combined phenolic hydroxyl groups and phenolic ethers can correspond to phenolic hydroxyl groups and phenolic ethers in an ortho position relative to at least one substituent, or about 60 wt % to about 95 wt %, or about 70 wt % to about 100 wt %. Additionally or alternately, in some aspects at least about 60 wt % of the combined phenolic hydroxyl groups and phenolic ethers in technical lignins and/or phenolic monomers and/or phenolic polymers in the pyrolytic lignin composition can correspond to phenolic hydroxyl groups and phenolic ethers in an ortho position relative to at least one substituent (optionally two substituents), or at least about 70 wt %, or at least about 80 wt %, such as up to about 95 wt % or up to about 100 wt %. In particular, about 60 wt % to about 100 wt % of the combined phenolic hydroxyl groups and phenolic ethers can correspond to phenolic hydroxyl groups and phenolic ethers in an ortho position relative to at least one substituent, or about 60 wt % to about 95 wt %, or about 70 wt % to about 100 wt %. In some aspects, at least about 50 wt % (or at least about 60 wt %, or at least about 70 wt %, such as up to about 95 wt % or up to about 100 wt %) of the phenolic hydroxyl groups and/or phenolic ether groups can be ortho to a methyl substituent, an ethyl substituent, a methoxy substituent, a hydroxyl substituent, an ether substituent, or a combination thereof. In particular, about 50 wt % to about 100 wt %, or about 50 wt % to about 95 wt %, or about 60 wt % to about 100 wt % of the phenolic hydroxyl groups and/or phenolic ether groups can be ortho to a methyl substituent, an ethyl substituent, a methoxy substituent, a hydroxyl substituent, an ether substituent, or a combination thereof.

In the structure shown in FIG. 3, the carbon atoms in benzylic units 311, 321, 331, 341, 351, and 361 can correspond to aromatic carbons. Additionally, the carbon atoms in linkage 328 can correspond to a conjugated pi-bond chain, and therefore the carbon atoms in linkage 328 can also correspond to aromatic carbons. In a hypothetical example where oxygen bonds 315, 335, and 365 correspond to hydrogen atoms, the structure in FIG. 3 can include a total of 46 carbons, with 38 of the carbons corresponding to aromatic carbons. This can be expressed as a ratio of aromatic carbons to aliphatic carbons of 38 to 8, or ˜3.75.

In a second hypothetical example, oxygen bonds 315, 335, and 365 can bond to terminating methyl groups, so that benzylic units 311, 331, and 361 can each include a methoxy substituent. The structure in FIG. 3 need not otherwise include a methoxy group. In this second hypothetical example, the total number of carbons in the structure could be 49 carbons, with 38 of the carbons corresponding to aromatic carbons. However, it has been determined that the aromatic versus aliphatic nature of a pyrolytic lignin composition can be better characterized by excluding carbons from methoxy groups when determining a ratio of aromatic versus aliphatic carbons. Therefore, when excluding methoxy groups, the ratio of aromatic carbons to aliphatic carbons (excluding methoxy groups) in this second hypothetical example can be expressed as 38 to 8, or ˜3.75. In some aspects, the ratio of aromatic carbons to aliphatic carbons, excluding methoxy groups, in a pyrolytic lignin composition can be at least about 2.3, or at least about 3.3, or at least about 4.0, such as up to about 10. In particular, the ratio of aromatic carbons to aliphatic carbons can be about 2.3 to about 10, or about 3.3 to about 10, or about 4.3 to about 10. Additionally or alternately, in some aspects the ratio of aromatic carbons to aliphatic carbons, excluding methoxy groups, in technical lignins and/or phenolic monomers and/or phenolic polymers in a pyrolytic lignin composition can be at least about 2.3, or at least about 3.3, or at least about 4.0, such as up to about 10. In particular, the ratio of aromatic carbons to aliphatic carbons can be about 2.3 to about 10, or about 3.3 to about 10, or about 4.3 to about 10.

In various aspects, a pyrolytic lignin composition can be characterized based on effective hydrogen index (EHI). In some aspects involving pyrolytic lignin formed from relatively sulfur-free biomass (such as less than 500 wppm sulfur), effective hydrogen index for a phenolic monomer, a phenolic polymer, a technical lignin, and/or a composition can be determined based on the number of hydrogen, oxygen, nitrogen, and carbon atoms. The effective hydrogen index can be calculated based on the formula EHI=[H−(2O+3N)/C], where H, O, N, and C correspond to the respective number of hydrogen, oxygen, nitrogen, and carbon atoms in a monomer/polymer/lignin/composition. In other aspects involving pyrolytic lignin formed from biomass with a higher sulfur concentration, effective hydrogen index can be calculated based on the formula EHI=[H−(2O+2S+3N)/C], where H, O, S, N, and C correspond to the respective number of hydrogen, oxygen, nitrogen, and carbon atoms in a monomer/polymer/lignin/composition. In various aspects, the effective hydrogen index for a pyrolytic lignin composition, or for the phenolic monomers and/or phenolic polymers and/or technical lignins in a pyrolytic lignin composition, can be about 1.0 to about 0.5, or about 0.9 to about 0.6.

In some aspects, at least a portion of the phenolic polymers in a pyrolytic lignin composition can correspond to natural lignins. In some aspects, at least a portion of the phenolic polymers can correspond to technical lignins. For example, about 30 wt % or less, or about 20 wt % or less, or about 10 wt % or less of the phenolic polymers can correspond to natural lignins, such as down to about 2 wt % or down to about 0 wt %. In particular, about 30 wt % to about 0 wt % of the phenolic polymers can correspond to natural lignins, or about 30 wt % to about 2 wt %, or about 20 wt % to about 0 wt %. Additionally or alternately, at least about 60 wt %, or at least about 70 wt %, or at least about 80 wt % of the phenolic polymers can correspond to technical lignins, such as up to about 95 wt % or up to about 100 wt %. In particular, about 60 wt % to about 100 wt % of the phenolic polymers can correspond to technical lignins, or about 60 wt % to about 95 wt %, or about 70 wt % to about 100 wt %.

In some aspects, a pyrolytic lignin composition can be characterized based on the heteroatom class for the composition and/or double bond equivalents. Heteroatom class and double bond equivalents can be determined based on Fourier transform-inductively coupled resonance-mass spectrometry (FT-ICR-MS). Heteroatom class can provide a relative abundance of compounds within a composition based on the number and type of heteroatoms in the compounds. Double bond equivalents can refer to the number of hydrogens present at a given carbon number in a composition. It is noted that double bond equivalents can also reflect hydrogen deficiencies due to other reasons, such as the presence of ring structures and/or heteroatoms.

In various aspects, pyrolytic lignin compositions can belong to heteroatom classes corresponding to about 2 oxygens to about 16 oxygens, or about 2 oxygens to about 14 oxygens. At least about 70 wt % of a pyrolytic lignin composition, or at least about 80 wt %, or at least about 90 wt %, such as up to about 98 wt % or up to about 100 wt %, can correspond to compounds belonging to a heteroatom class corresponding to about 2 oxygens to about 16 oxygens, or about 2 oxygens to about 14 oxygens. In particular, about 70 wt % to about 100 wt % of a pyrolytic lignin composition can correspond to compounds belonging to a heteroatom class corresponding to about 2 oxygens to about 16 oxygens, or about 2 oxygens to about 14 oxygens, or about 70 wt % to about 98 wt %, or about 80 wt % to about 100 wt %. Optionally, at least about 70 wt % of a pyrolytic composition, or at least about 80 wt %, or at least about 90 wt %, such as up to about 98 wt % or up to about 100 wt %, can correspond to compounds belonging to a heteroatom class not including nitrogen atoms. In particular, about 70 wt % to about 100 wt %, or about 70 wt % to about 98 wt %, or about 80 wt % to about 100 wt % can correspond to compounds belonging to a heteroatom class not including nitrogen atoms.

A pyrolytic lignin composition can be suitable, for example, for use as an antioxidant additive, e.g., for lubricants and/or greases. Antioxidant capabilities of a pyrolytic lignin composition can be determined, for example, by blending a pyrolytic lignin composition with a lubricant or grease and then performing pressure differential scanning calorimetry (PDSC) on the sample, such as according to ASTM D6186. Pyrolytic lignin compositions can allow for increased times and/or temperatures before initiation of oxidation during a PDSC test.

### Modification of Pyrolytic Lignin Compositions

The pyrolytic lignin compositions described herein can provide beneficial antioxidant properties, for example, when used as an additive for a lubricant or grease. In some aspects, a pyrolytic lignin composition may have limited solubility in a target lubricant or grease. One option for improving the solubility of a pyrolytic lignin composition can be to functionalize a portion of the phenolic hydroxyl groups in the pyrolytic lignin composition. This can increase the hydrophobicity of the pyrolytic lignin composition to improve solubility. An example a suitable process for increasing solubility can be partial acetylation of a composition. Other types of functional groups that can increase hydrophobicity can include, but are not limited to, alkyl groups and/or ester groups, such as alkyl groups and/or ester groups including about 2 to about 20 carbons, or about 2 to about 10 carbons.

### ADDITIONAL EMBODIMENTS

### Embodiment 1

A technical lignin composition comprising: at least about 60 wt % phenolic polymers, at least about 75 wt % combined phenolic monomers and phenolic polymers, or a combination thereof; at least about 50 wt % of the hydroxyl groups in the technical lignin composition comprising phenolic hydroxyl groups; at least about 60% of the phenolic hydroxyl groups comprising a phenolic hydroxyl group in an ortho position relative to at least one substituent; about 70% or less of linkages connecting benzylic units in the phenolic polymers comprising an ether group or a carbonyl group; and about 50% or less of linkages connecting benzylic units in the phenolic polymers comprising β-O-4 linkages; wherein at least one of the phenolic polymers and the technical lignin composition further comprises a ratio of aromatic carbons to aliphatic carbons, exclusive of methoxy groups, of at least about 2.3.

### Embodiment 2

A method for forming a technical lignin composition, comprising: pyrolyzing a biomass feed to form a pyrolysis product; mixing at least a portion of the pyrolysis product with water to form a mixture; and separating a water phase of the mixture from a second phase comprising the technical lignin composition, wherein the technical lignin composition comprises: at least about 60 wt % phenolic polymers, at least about 75 wt % combined phenolic monomers and phenolic polymers, or a combination thereof; at least about 50 wt % of the hydroxyl groups in the technical lignin composition comprising phenolic hydroxyl groups; at least about 60% of the phenolic hydroxyl groups comprising a phenolic hydroxyl group in an ortho position relative to at least one substituent; about 70% or less of linkages connecting benzylic units in the phenolic polymers comprising an ether group or a carbonyl group; and about 50% or less of linkages connecting benzylic units in the phenolic polymers comprising β-O-4 linkages; wherein at least one of the phenolic polymers and the technical lignin composition further comprises a ratio of aromatic carbons to aliphatic carbons, exclusive of methoxy groups, of at least about 2.3.

### Embodiment 3

The technical lignin composition or the method of forming a technical lignin composition of any of the above embodiments, wherein at least about 60% of combined phenolic ether groups and phenolic hydroxyl groups comprise a phenolic ether group or a phenolic hydroxyl group in an ortho position relative to at least one substituent.

### Embodiment 4

The technical lignin composition or the method of forming a technical lignin composition of any of the above embodiments, wherein the technical lignin composition or pyrolytic lignin composition comprises an effective hydrogen index of about 1.0 or less; or wherein the combined phenolic monomers and phenolic polymers comprise an effective hydrogen index of about 1.0 or less; or a combination thereof.

### Embodiment 5

The technical lignin composition or the method of forming a technical lignin composition of any of the above embodiments, wherein the composition comprises about 5.0 wt % or less of sugars.

### Embodiment 6

The technical lignin composition or the method of forming a technical lignin composition of any of the above embodiments, wherein the at least about 60% of the phenolic hydroxyl groups comprise a phenolic hydroxyl group in an ortho position relative to two substituents; or wherein the at least about 60% of the combined phenolic ether groups and phenolic hydroxyl groups comprise a phenolic ether group or a phenolic hydroxyl group in an ortho position relative to two substituents; or a combination thereof.

### Embodiment 7

The technical lignin composition or the method of forming a technical lignin composition of any of the above embodiments, wherein the at least about 60% of the phenolic hydroxyl groups comprise phenolic hydroxyl groups in an ortho position relative to a methyl substituent, an ethyl substituent, a methoxy substituent, a hydroxyl substituent, an ether substituent, or a combination thereof or wherein the at least about 60% of the combined phenolic ether groups and phenolic hydroxyl groups comprise phenolic ether groups and phenolic hydroxyl groups in an ortho position relative to a methyl substituent, an ethyl substituent, a methoxy substituent, a hydroxyl substituent, an ether substituent, or a combination thereof.

### Embodiment 8

The technical lignin composition or the method of forming a technical lignin composition of any of the above embodiments, wherein about 30 wt % or less of the phenolic polymers comprise natural lignins, or about 20 wt % or less, or about 10 wt % or less.

### Embodiment 9

The technical lignin composition or the method of forming a technical lignin composition of any of the above embodiments, wherein at least about 60 wt % of the phenolic polymers comprise technical lignins, or at least about 70 wt %, or at least about 80 wt %; or wherein at least about 60 wt % of the phenolic polymers comprise pyrolytic lignins or at least about 70 wt %, or at least about 80 wt %; or a combination thereof.

### Embodiment 10

The technical lignin composition or the method of forming a technical lignin composition of any of the above embodiments, wherein about 50% or less of linkages connecting benzylic units in the phenolic polymers comprise an ether group or a carbonyl group; wherein about 50% or less of linkages connecting benzylic units in the technical lignins comprise an ether group or a carbonyl group; or a combination thereof.

### Embodiment 11

The method of forming a technical lignin composition of any of Embodiments 2-10, wherein the at least a portion of the pyrolysis product comprises a pyrolysis oil.

### Embodiment 12

The method of forming a technical lignin composition of any of Embodiments 2-11, further comprising fractionating the pyrolysis product to form a first fraction comprising phenolic monomers, phenolic polymers, or a combination thereof and a second lower boiling fraction.

### Embodiment 13

The method of forming a technical lignin composition of any of Embodiments 2-12, wherein separating a water phase of the mixture from a second phase comprises: settling the mixture for a settling time to form the water phase and the second phase; and separating the formed water phase from the second phase.

### Embodiment 14

The method of forming a technical lignin composition of any of Embodiments 2-13, further comprising functionalizing at least a portion of the phenolic hydroxyl groups in the pyrolytic lignin composition, the functionalizing at least a portion of the phenolic hydroxyl groups optionally comprising performing alkylation, performing a partial acetylation, or a combination thereof.

### EXAMPLES

### Example 1—Production of Pyrolytic Lignin Compositions

Pyrolytic lignin compositions were prepared by two different methods. In a first method, pyrolysis was performed on biomass to form a pyrolysis oil. Water was added to the resulting pyrolysis oil in about a 1:1 ratio to form a mixture. The mixture was allowed to settle for about 30 minutes on a shaker table, followed by centrifugation at 2500 rpm for about 15 minutes. The top aqueous phase was then decanted off, leaving behind an oil-based phase. The oil-based phase was then extracted using dichloromethane to form a first composition (Pyrolytic Lignin Composition 1) that appeared to be insoluble in dichloromethane and a second composition that appeared to be soluble in dichloromethane (Pyrolytic Lignin Composition 2). It was believed that Pyrolytic Lignin Composition 1 includes a substantial portion of phenolic dimers and/or other phenolic polymers, while Pyrolytic Lignin Composition 2 included a substantial portion of phenolic monomers.

In another method, pyrolysis was performed on red oak biomass to form a pyrolysis oil. The pyrolysis oil was recovered using a fractionation system, such as a fractionation system similar to the configuration shown in FIG. 2. The fractions boiling at about 100° C. or greater were then water washed to remove sugars. The resulting washed fractions were then extracted using toluene to form a third composition (Pyrolytic Lignin Composition 3) that appeared to be insoluble in toluene and a fourth composition (Pyrolytic Lignin Composition 4) that appeared to be soluble in toluene. It was believed that Pyrolytic Lignin Composition 3 included a substantial portion of phenolic polymers, while Pyrolytic Lignin Composition 4 included a substantial portion of phenolic monomers.

### Example 2—Pressure Differential Scanning Calorimetry

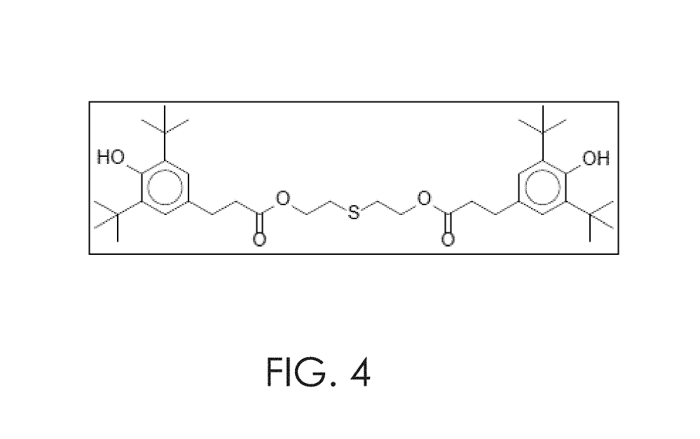

Pressure differential scanning calorimetry (PDSC) was used to investigate the antioxidant performance of Pyrolytic Lignin Compositions 1-4, relative to two commercially available antioxidant products. One comparative antioxidant was 2,6-di-tert-butyl-4-methylphenol (Reference 1). The other comparative antioxidant, thiobis(ethane-2,1-diyl)bis(3-(3,5-tert-butyl-4-hydroxyphenyl)propanoate corresponded to the structure shown in FIG. 4 (Reference 2).

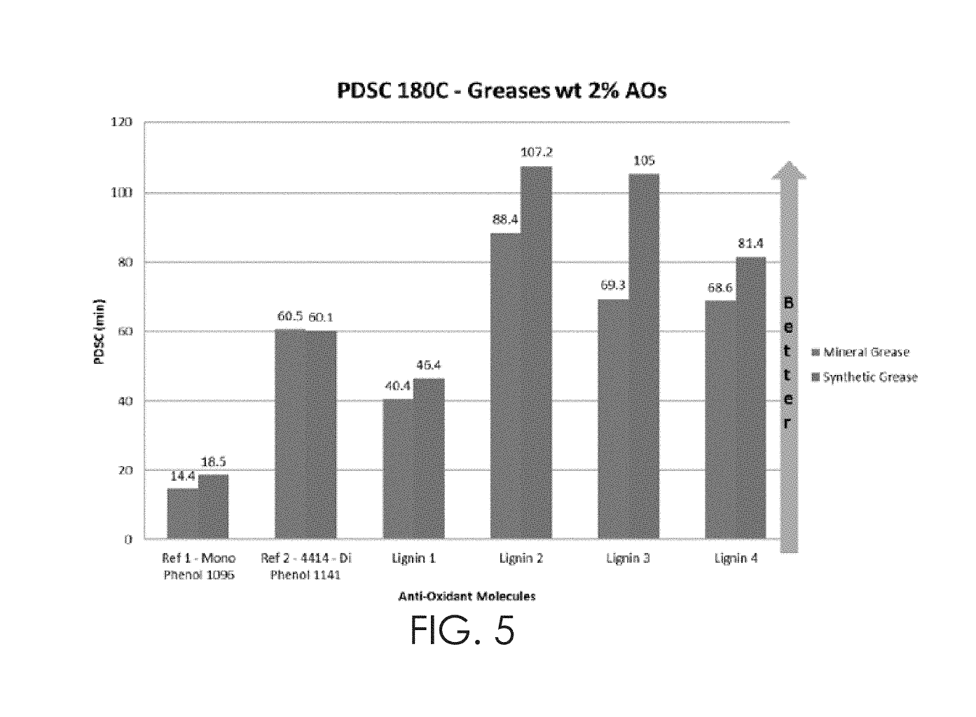

For characterization, about 2 wt % of Pyrolytic Lignin Compositions 1-4 and the two comparative antioxidants were added to a commercially available mineral grease and a commercially available synthetic grease. Results from performing PDSC at ˜180° C. on the various samples are shown in FIG. 5, which shows the amount of time required for the onset of oxidation. In FIG. 5, the results from testing with mineral grease correspond to the left bar in each pair of bars, while the results from testing with the synthetic grease correspond to the right bar. FIG. 5 appears to show that Pyrolytic Lignin Compositions 1-4 exhibited improved performance (antioxidant properties) relative to Reference 1. Pyrolytic Lignin Compositions 2-4 also appeared to exhibit improved performance (antioxidant properties) relative to Reference 2. Pyrolytic Lignin Composition 2, which was believed to include a substantial portion of phenolic monomers, and Pyrolytic Lignin Composition 3, which was believed to include a substantial portion of phenolic dimers and/or phenolic polymers, appeared to exhibit improved results relative to Pyrolytic Lignin Compositions 1 and 4, which demonstrates that the method of pyrolysis and extraction procedure can affect the composition and antioxidant performance of the lignin extracts.

### Example 3—Addition to Lubricant Composition

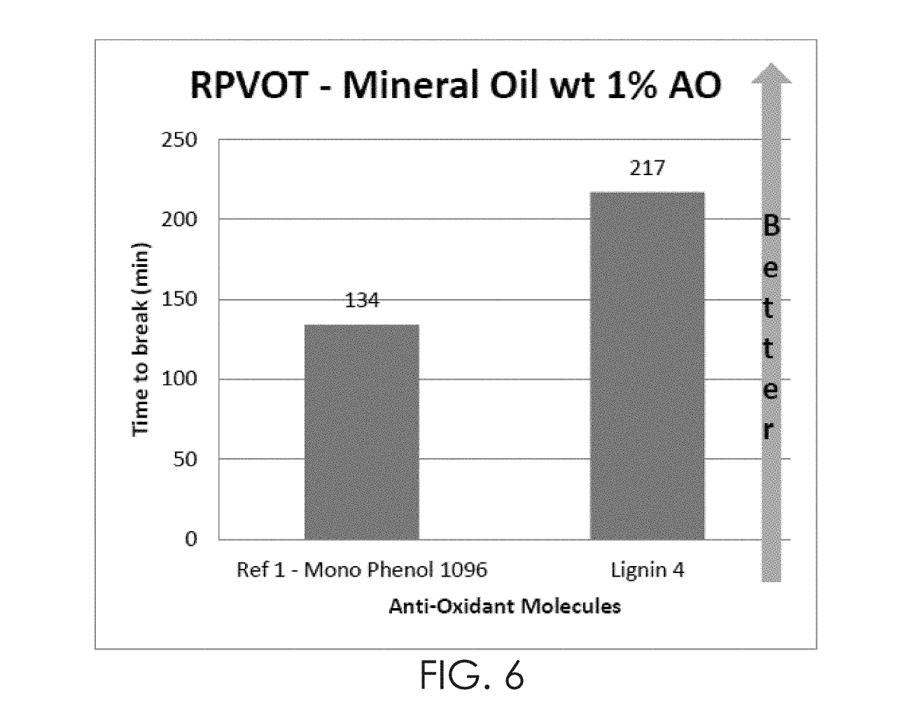

Pyrolytic Lignin Composition 4 was added to a mineral lubricant base oil in an amount of about 1.0 wt %. About 1.0 wt % of Reference 1 was added to another sample. The two samples were then tested using a Rotating Pressure Vessel Oxidation Test (RPVOT), according to ASTM D2272. FIG. 6 shows results from the RPVOT. As shown in FIG. 6, Pyrolytic Lignin Composition 4 appeared to allow substantially longer exposure to oxidation conditions prior to degradation of the lubricant.

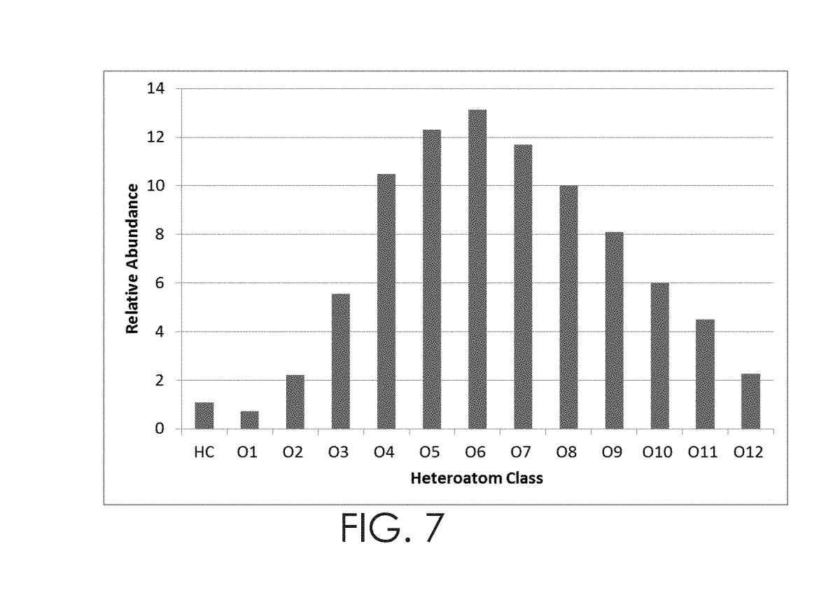

FIG. 7 shows an example of characterization of Pyrolytic Lignin Composition 1 using FT-ICR-MS. FIG. 7 shows the oxygen heteroatom class for the compounds in the composition. FIG. 7 appears to show that about 99 wt % of the phenolic polymers in Pyrolytic Lignin Composition 1 exhibited an oxygen heteroatom class of about 2 to about 12.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

The present invention has been described above with reference to numerous embodiments and specific examples. Many variations will suggest themselves to those skilled in this art in light of the above detailed description. All such obvious variations are within the full intended scope of the appended claims.

1.-21. (canceled)

22. The use of a technical lignin composition as an antioxidant additive for a mineral synthetic grease or mineral lubricant base oil, the lignin composition comprising:
at least about 60 wt % phenolic polymers, at least about 75 wt % combined phenolic monomers and phenolic polymers, or a combination thereof,
at least about 50 wt % of the hydroxyl groups in the technical lignin composition comprising phenolic hydroxyl groups,
at least about 60% of the phenolic hydroxyl groups comprising a phenolic hydroxyl group in an ortho position relative to at least one substituent,
about 70% or less of linkages connecting benzylic units in the phenolic polymers comprising an ether group or a carbonyl group,
about 50% or less of linkages connecting benzylic units in the phenolic polymers comprising β-O-4 linkages,
the phenolic polymers further comprising a ratio of aromatic carbons to aliphatic carbons, exclusive of methoxy groups, of at least about 2.3.

23. The use of claim 1, wherein the combined phenolic monomers and phenolic polymers comprise an effective hydrogen index of about 1.0 or less.

24. The use of claim 1, wherein at least about 60% of the phenolic hydroxyl groups comprise a phenolic hydroxyl group in an ortho position relative to two substituents.

25. The use of claim 1, wherein the at least about 60% of the phenolic hydroxyl groups comprise phenolic hydroxyl groups in an ortho position relative to a methyl substituent, an ethyl substituent, a methoxy substituent, a hydroxyl substituent, an ether substituent, or a combination thereof.

26. The use of claim 1, wherein about 30 wt % or less of the phenolic polymers comprise natural lignins.

27. The use of claim 1, wherein at least about 60 wt % of the phenolic polymers comprise technical lignins.

28. The use of claim 1, wherein at least about 60 wt % of the phenolic polymers comprise pyrolytic lignins.

29. The use of claim 1, wherein about 50% or less of linkages connecting benzylic units in the phenolic polymers comprise an ether group or a carbonyl group.

30. The use of claim 1, wherein the composition comprises about 5.0 wt % or less of sugars.

31. The use of a technical lignin composition as an antioxidant additive for a mineral synthetic grease or mineral lubricant base oil, the lignin composition comprising:
at least about 60 wt % phenolic polymers, at least about 75 wt % combined phenolic monomers and phenolic polymers, or a combination thereof,
at least about 50 wt % of the hydroxyl groups in the technical lignin composition comprising phenolic hydroxyl groups,
at least about 60% of combined phenolic ether groups and phenolic hydroxyl groups comprising a phenolic ether group or a phenolic hydroxyl group in an ortho position relative to at least one substituent,
about 70% or less of linkages connecting benzylic units in the phenolic polymers comprising an ether group or a carbonyl group,
about 50% or less of linkages connecting benzylic units in the phenolic polymers comprising β-O-4 linkages,
the technical lignin composition further comprising a ratio of aromatic carbons to aliphatic carbons, exclusive of methoxy groups, of at least about 2.3.

32. The use of claim 10, wherein the composition comprises an effective hydrogen index of about 1.0 or less.

33. The use of claim 10, wherein at least about 60% of the combined phenolic ether groups and phenolic hydroxyl groups comprise a phenolic ether group or a phenolic hydroxyl group in an ortho position relative to two substituents.

34. The use of claim 10, wherein the at least about 60% of the phenolic hydroxyl groups comprise phenolic hydroxyl groups in an ortho position relative to a methyl substituent, an ethyl substituent, a methoxy substituent, a hydroxyl substituent, an ether substituent, or a combination thereof.

35. The use of claim 10, wherein about 50% or less of linkages connecting benzylic units in the phenolic polymers comprise an ether group or a carbonyl group.
